(19) United States
(12) Patent Application Publication
(10) Pub. No.: US 2026/0322217 A1
(43) Pub. Date: Oct. 15, 2026

(54) SLOT LINER COOLING FOR ELECTRIC MACHINE

(71) Applicant: BorgWarner Inc., Auburn Hills, MI (US)

(72) Inventors: Andrew Dragon, Fishers, IN (US); Ben Kang, Noblesville, IN (US)

(21) Appl. No.: 19/177,716

(22) Filed: Apr. 14, 2025

(51) Int. Cl. H02K 9/193

(52) U.S. Cl. CPC H02K 9/193

(57) ABSTRACT

A stator for an electric machine includes an annular body and multiple radially inward slots. The stator defines a cooling fluid domain having a fluid inlet and a cooling fluid jacket at a radially outward portion of the stator. The cooling fluid domain further includes multiple cooling fluid connections. Each cooling fluid connection extending from the cooling fluid jacket to a corresponding radially inward slot such that each radially inward slot of the radially inward slots receives cooling fluid.

### BACKGROUND OF THE INVENTION

Electric machines are often cooled using fluids directed to various portions of the electric machine. Improving cooling is a consistent interest particularly with power requirements of electric machines inexorably increasing over time. Accordingly, the art will welcome innovations that improve cooling of components within an electric machine.

### BRIEF DESCRIPTION OF THE INVENTION

Disclosed is an embodiment of a stator for an electric machine includes an annular body and a plurality of radially inward slots. The stator defines a cooling fluid domain having a fluid inlet and a cooling fluid jacket at a radially outward portion of the stator. The cooling fluid domain further includes a plurality of cooling fluid connections. Each cooling fluid connection extending from the cooling fluid jacket to a corresponding radially inward slot such that each radially inward slot of the plurality of radially inward slots receives cooling fluid.

Further disclosed is an embodiment of an electric machine including a stator having an annular body and a rotor radially inward of the stator. The stator includes an annular body and a plurality of radially inward slots. The stator defines a cooling fluid domain having a fluid inlet and a cooling fluid jacket at a radially outward portion of the stator. The cooling fluid domain further includes a plurality of cooling fluid connections. Each cooling fluid connection extending from the cooling fluid jacket to a corresponding radially inward slot such that each radially inward slot of the plurality of radially inward slots receives cooling fluid.

Further disclosed is an embodiment of a method for cooling stator conductors in an electric machine. The method includes providing a cooling fluid to a fluid domain at a radially outward cooling fluid inlet. The cooling fluid domain defines a cooling fluid jacket at a radially outward portion of a stator. The fluid domain further defines a plurality of fluid connections with each cooling fluid connection extending from the cooling fluid jacket to a corresponding radially inward slot. A portion of the cooling fluid domain defined within each radially inward slot is divided.

### BRIEF DESCRIPTION OF THE DRAWINGS

The following descriptions should not be considered limiting in any way. With reference to the accompanying drawings, like elements are numbered alike:

FIG. 1 is an end view of one quarter of an electric machine according to one example;

FIG. 2 is an isometric view of a fluid domain of the one quarter of an electric machine of FIG. 1;

FIG. 3A illustrates a metering feature of the fluid domain of FIG. 2, according to one example;

FIG. 3B illustrates a metering feature of the fluid domain of FIG. 2, according to one example;

FIG. 3C illustrates a metering feature of the fluid domain of FIG. 2, according to one example;

FIG. 4 illustrates a stator winding slot of FIG. 1, isolated from a remainder of the electric machine;

FIG. 5 illustrates a slot liner for use in the stator winding slot of FIG. 4 according to one example;

FIG. 6 illustrates the slot liner of FIG. 5, including conductor windings according to one example;

FIG. 7 illustrates a fluid domain of the slot liner of FIG. 6;

FIG. 8 illustrates an alternate slot liner for use in the stater winding slot of FIG. 4 according to one example;

FIG. 9A illustrates a partial view of a slot liner including a set of rectangular support pins in an isometric view;

FIG. 9B illustrates a partial view of a slot liner including a set of rectangular support pins in a side view;

FIG. 10A illustrates a partial view of a slot liner including a set of circular support fins in an isometric view;

FIG. 10B illustrates a partial view of a slot liner including a set of circular support fins in a circumferentially facing side view;

FIG. 11A illustrates a partial view of a slot liner including a set of foil shaped support fins in an isometric view;

FIG. 11B illustrates a partial view of a slot liner including a set of foil shaped support fins in a circumferentially facing side view;

FIG. 12A illustrates a partial view of a slot liner including a set of zigzag support fins in an isometric view;

FIG. 12B illustrates a partial view of a slot liner including a set of zigzag support fins in a circumferentially facing side view;

FIG. 13 illustrates an isometric view of a slot liner including a zigzag flowpath intruding channels; and

FIG. 14 illustrates an alternative fluid domain omitting a radially outward cooling jacket;

FIG. 15 illustrates an axial end view of ala single ternate slot configuration of the electric machine of FIG. 1; and

FIG. 16 illustrates an isometric view of the single alternate slot configuration of FIG. 15.

### DETAILED DESCRIPTION OF THE INVENTION

A detailed description of one or more embodiments of the disclosed apparatus and method are presented herein by way of exemplification and not limitation with reference to the Figures.

Referring to general electric machine operations, as an electric machine operates electromagnetic losses are generated on each component of the electric machine (e.g., rotor lamination, stator lamination, magnets, conductors, etc.). The losses are applied to the component as heat generation and result in increasing temperatures of the electric machine. Existing electric machines provide cooling through the use of a cooling jacket, fluid spray on winding turns and/or fluid cooling through an internal cooling path in the rotor.

When an electric machine is operating at peak performance, the highest losses typically occur on conductors within the stator resulting in correspondingly high increases in temperature at the stator conductors. If the temperature exceeds a certain high temperature (e.g. 180-200 degrees C), the conductor insulation life is reduced, decreasing an effective lifespan of the electric machine.

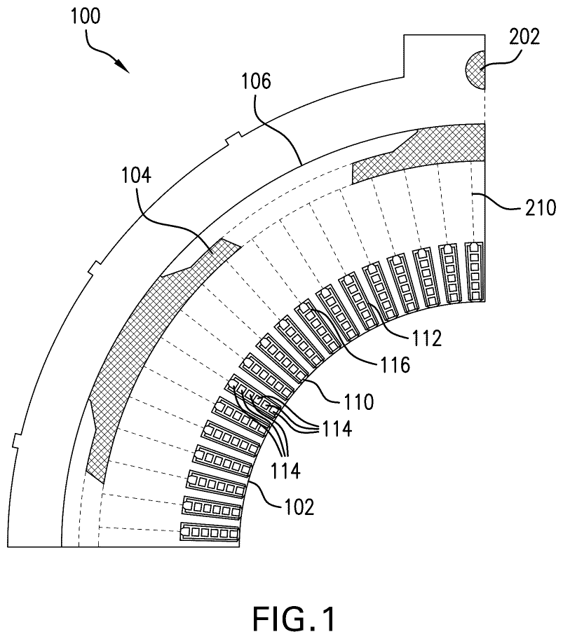

FIG. 1 illustrates a partial end view of an electrical machine. The partial end view is a one quarter view of a stator portion 100 of a 72 slot electric machine. The stator portion 100 includes 18 slots 110 at a radially inward edge 102 of the stator portion 100. Each slot 110 includes a liner 112 and a set of conductors 114. A gap between the liner 112 and the conductors 114 forms a fluid domain through which cooling fluid is passed. The fluid cooling flow and fluid domain features described herein can also be utilized in other machine designs including electric machines having a different number and/or arrangement of slots.

During operation the conductors 114 within the stator portion 100 generate heat. In certain existing systems, the heat is dissipated by applying a cooling path (alternately referred to as a cooling jacket) defined at an outer surface of the stator. However, a significant portion of heat generation due to the conductors is localized at the inner edge 102 of the stator portion 100. As a result, cooling generated by applying a cooling fluid to the outer surface, or only to channels 104 positioned at the radially outer edge 106, can be improved by directly flowing the cooling fluid through each of the slots 110.

Even in systems where cooling fluid is generally flowed to the slots 110, the thermal resistance due to the slot liner 112 between the heating source and the cooling source of existing systems resists cooling. To address this resistance, each slot is divided in a parallel thickness which provides two primary cooling paths, thereby increasing the cooling capabilities of the stator 100.

The structure illustrated in FIG. 1 provides cooling in direct contact with the conductors 114, thereby improving the efficiency of the cooling. In addition to dividing the cooling paths, the configuration of the slot liner 116 provides combined functionalities of voltage isolation, fluid flow path control, and maintaining the conductors 114 in a correct position within the slot 110.

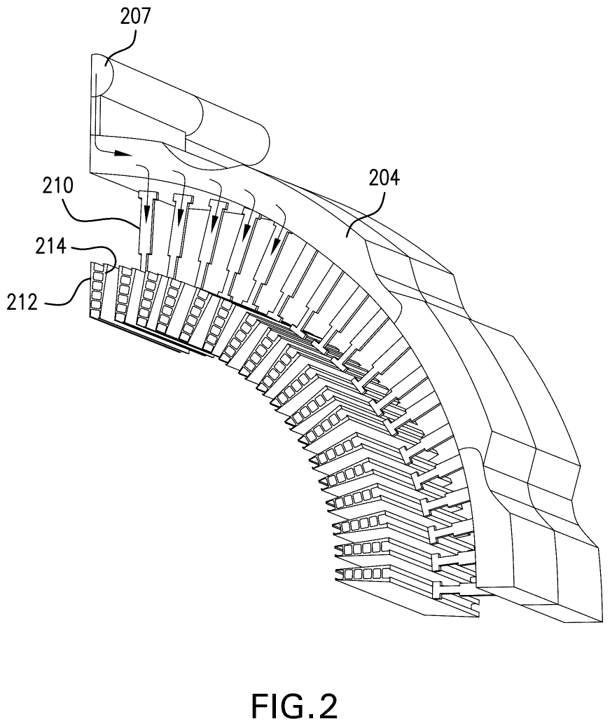

With continued reference to FIG. 1, FIG. 2 provides an isometric negative space view of fluid within the stator portion 100. The negative space view of the fluid is alternately referred to as a fluid domain 200.

The fluid domain 200 includes an inlet portion 202 where cooling fluid is received into the stator portion 100. The inlet portion 202 is connected to an outer circumference cooling fluid section 204. The outer circumference cooling fluid section 204 defines the channels 104. Each slot 110 is connected to the channel 104 by a corresponding cooling fluid connection 210.

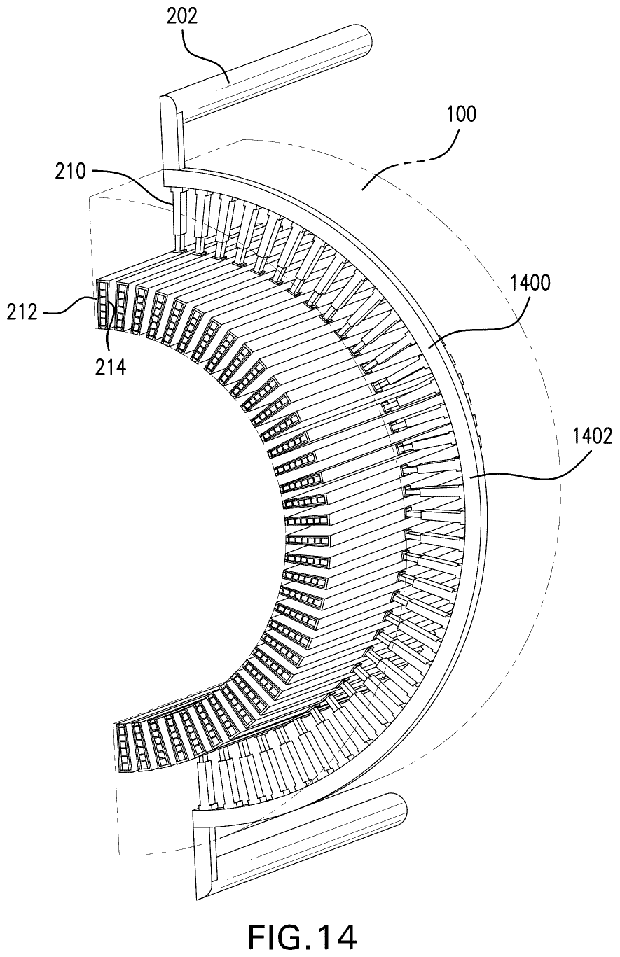

In one alternative embodiment, illustrated in FIG. 14, a fluid domain 1400 within the stator portion 100 omits the outer circumference cooling fluid section 204 (FIG. 2) and replaces the outer circumference cooling fluid section with an axially short cooling fluid distribution channel 1402. As with the embodiment of FIG. 2, the fluid domain 1400 includes an inlet portion 202 connected to the cooling fluid distribution channel 1402 with the cooling fluid distribution channel 1402 providing cooling fluid to each of the cooling fluid connections 210. The alternative embodiment of FIG. 14 can be used in electrical machines where cooling is not required at the outer circumference of the stator, thereby allowing the electric machine to be axially shorter.

With continued reference to FIGS. 1 and 2, FIGS. 3A-C illustrate end views of multiple configurations of the cooling fluid connections 210. Any given stator portion 100 may utilize one, two, or all of the variations of the cooling fluid connections 210 within a single component, and the variations are not mutually exclusive.

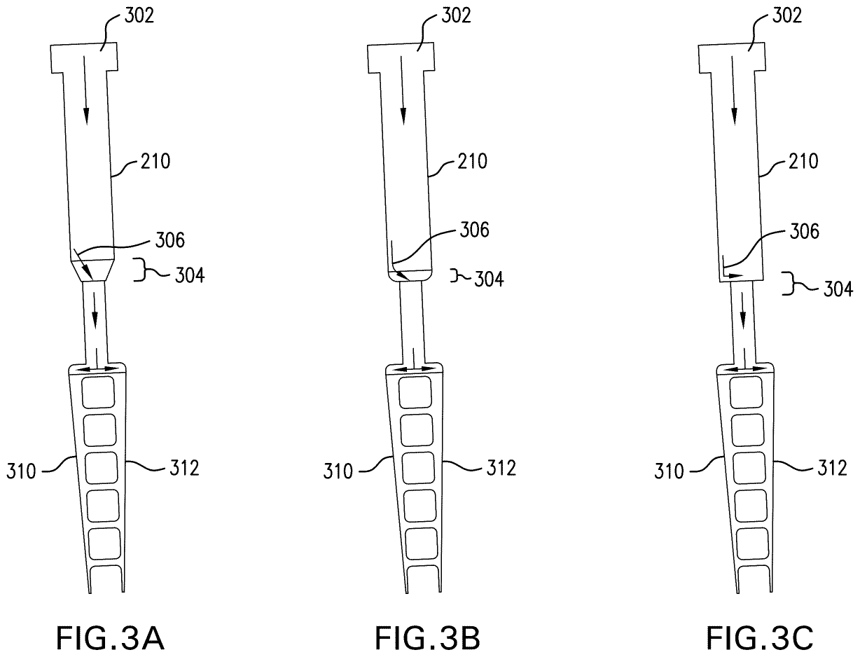

Each of the fluid connections 210 receives the cooling fluid from a radially outward end 302 and passes the cooling fluid to a metering section 304. In the first example (FIG. 3A) the metering section 304 is an angled portion of an outer wall defining the fluid connection 210 and constricting a flowpath 306 through the fluid connection 210. In the second example (FIG. 3B), the metering section 304 is a rounded portion of the outer wall defining the fluid connection 210 and functions generally similarly to the cooling fluid metering section 304 of FIG. 3A. In the third example (FIG. 3C), the metering section 304 is a flat wall section that is normal to, or approximately normal to, the flowpath 306.

Downstream of the metering section 304, the flowpath 306 is split into two parallel paths 310, 312, with each parallel path feeding cooling fluid to one of a first divided portion 212 and a second divided portion 214 of the corresponding slot 110. The cooling fluid proceeds through the slot 110 and is sprayed out each axial end of the slots 110, thereby providing further cooling for any components radially inwardly of the stator portion 100. In one example, such components include a rotor portion of the electric machine.

In some cases, the sprayed cooling fluid may be recovered via a corresponding cooling fluid recovery mechanism according to known methods. In other cases, the cooling fluid may be considered spent and not recovered, depending on the needs of a given electrical machine, the type of cooling fluid utilized, or any other relevant factors.

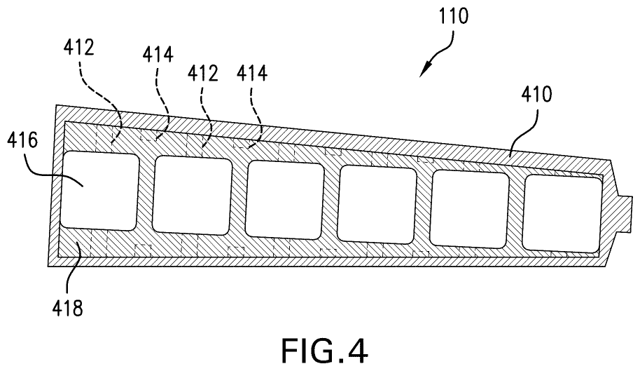

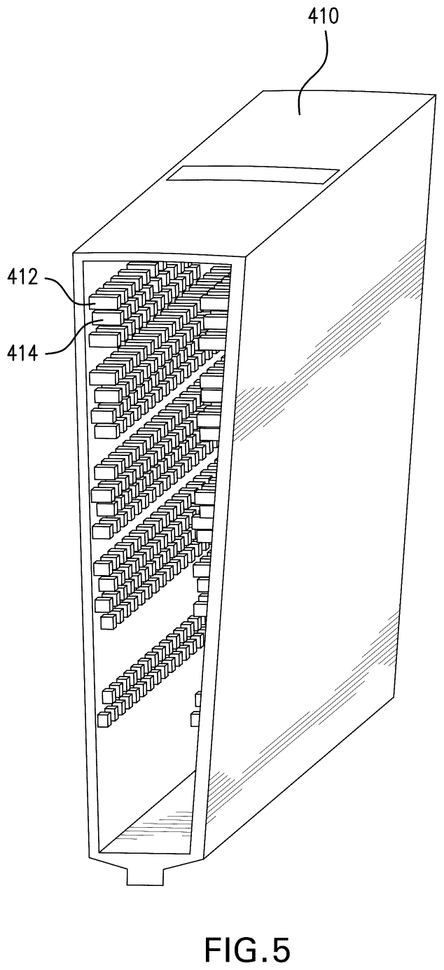

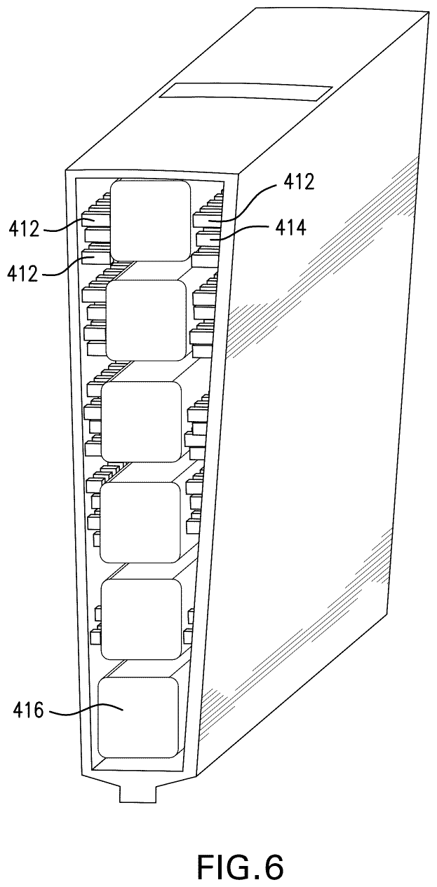

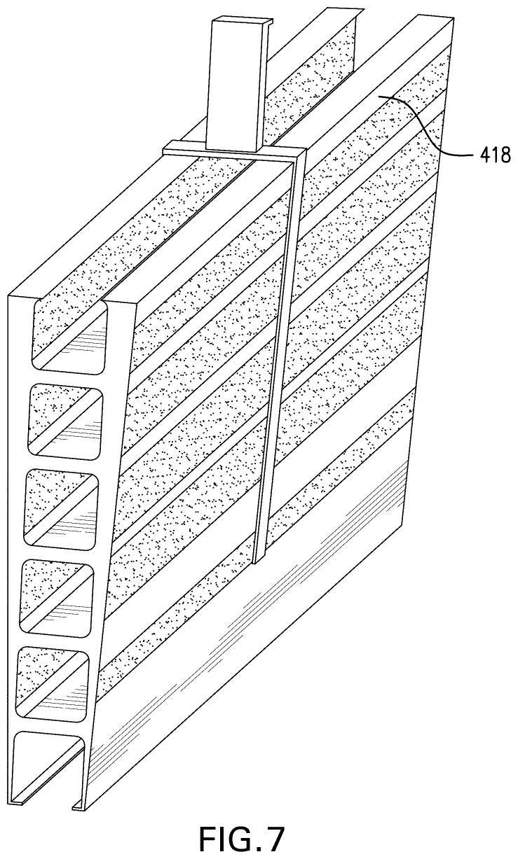

With continued reference to FIGS. 1-3C, FIG. 4 illustrates an end view of a single slot 110 including a liner 410, FIG. 5 illustrates a slot liner 410 for the slot 110, FIG. 6 illustrates the slot liner 410 with conductor windings 416 in place, and FIG. 7 illustrates a fluid domain 418 defined by the slot liner 410 and the conductor windings 416.

The liner 410 is electrically non-conductive and includes a set of fins 412, 414 protruding inwardly from the liner 410. Conductor windings 416 are defined within the liner 410 and provide the electrical windings of the stator. The conductor windings 416 are maintained in position, relative to the liner 410 by a subset of the fins 412, with the subset of fins 412 including one or more fins contacting each conductor winding 416. An empty space between the liner 410, the conductor windings 416 and the fins 412, 414 defines the fluid domain 418.

In some examples, the subset of fins 412 maintaining the conductor windings 416 in position are longer than remaining fins 414.

In some examples, the set of fins 412, 414 can include multiple fin shapes, lengths, and cross sections. The particular shapes, lengths, cross sections, and similar dimensions of each fin 412, 414 can be tailored to impart particular flow characteristics on the cooling fluid passing around the fin 412, 414 with the tailoring being dependent on the needs of a given electric machine including the operational parameters of the electric machine and the environment in which the electric machine is expected to be operating During operation, the fins 412, 414 agitate the flow of cooling fluid, thereby improving cooling performance by disrupting a boundary layer within the fluid flow near the liner 410.

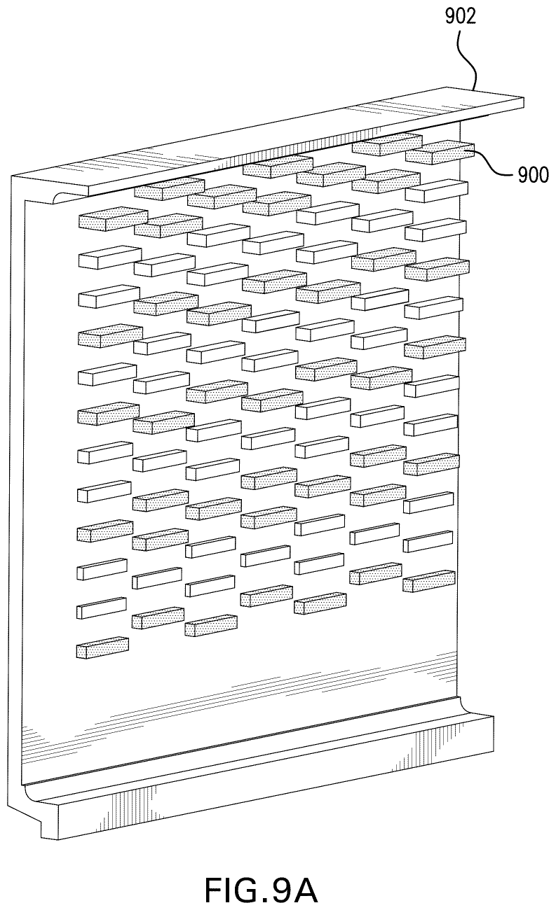

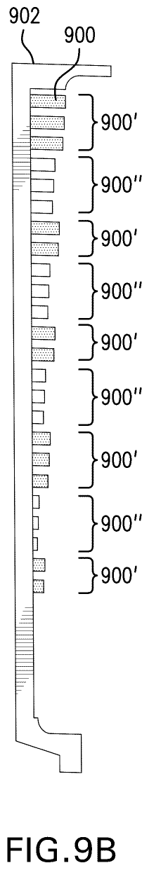

With continued reference to FIGS. 1-8, FIG. 9A illustrates an isometric view and FIG. 9B illustrates an axial facing side view including fins 900 having a rectangular profile. As used herein, the profile of a fin 900 refers to a shape of a two dimensional cross section of the fin 900. In the example of FIG. 9B, the slot liner 902 includes two sets of fins 900 (900′ and 900″).

A first set of fins 900′ extends circumferentially outward from the slot liner 902 to a circumferential length sufficient to contact the conductors 114 (FIG. 1) within the slot. The first set of fins 900′ functions both as a structural support maintaining the conductors 114 at a correct circumferential position in the slot and as flow turbulators that impart a turbulation on the cooling fluid flow.

A second set of fins 900″ extend circumferentially outward from the slot liner 902 to a circumferential length shorter than would be required to contact the conductors 114 within the slot and serve only to impart turbulation on the cooling fluid flow.

In alternative examples, the fins 900 can all belong to the set 900′, and the set 900″ may be omitted.

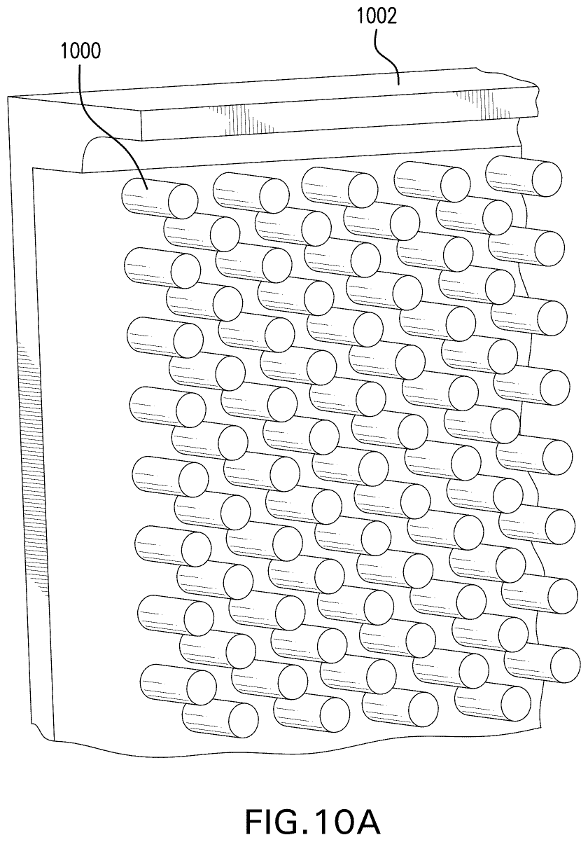

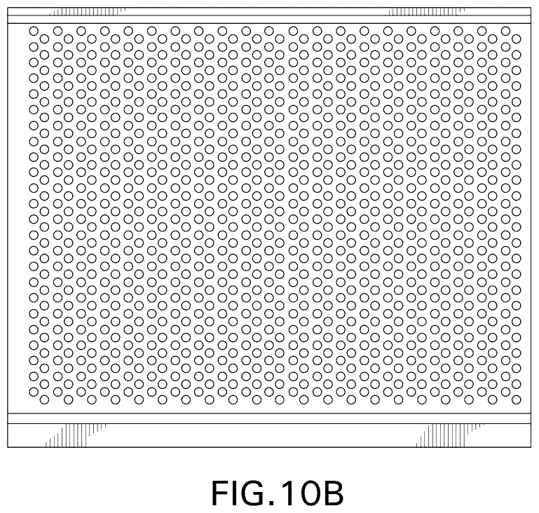

With continued reference to FIGS. 1-8, FIG. 10A illustrates a partial isometric view and FIG. 10B illustrates a circumferentially facing side view of a slot liner 1002 including fins 1000 having a circular profile. In the example of FIG. 10A, all the fins 1000 extend the same circumferential distance from the slot liner 1002. In alternative examples, the fins 1000 may extend varying lengths, as with the fins 900 of FIGS. 9A and 9B.

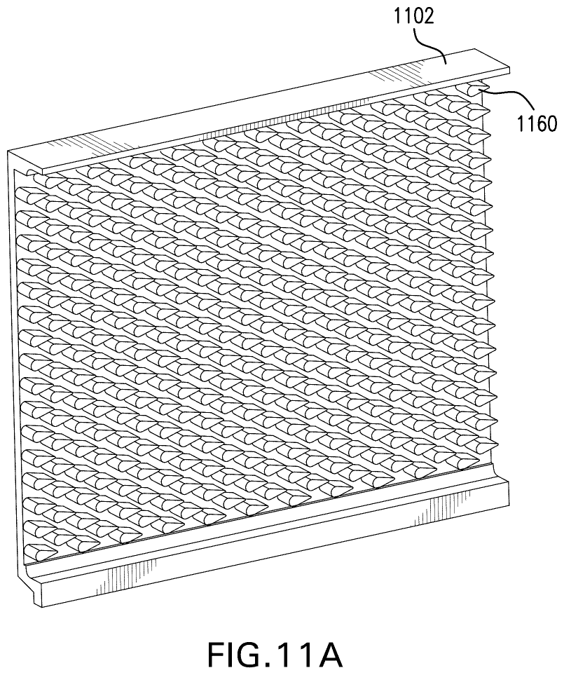

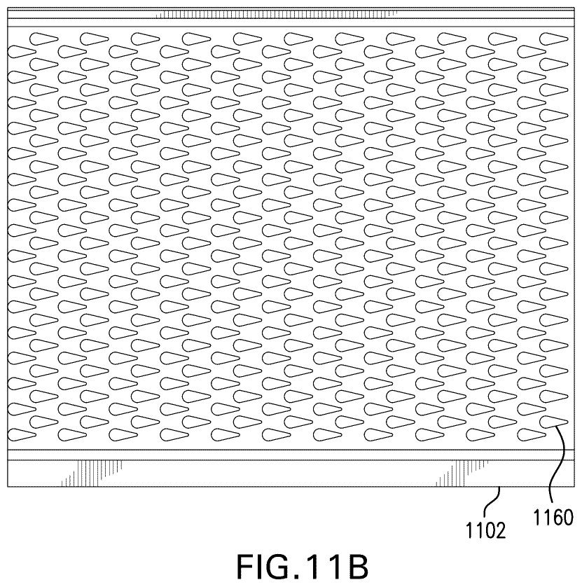

With continued reference to FIGS. 1-8, FIG. 11A illustrates an isometric view and FIG. 11B illustrates a circumferentially facing side view of a slot liner 1102 including fins 1160 having a foil profile. In the example of FIG. 11, all the fins 1160 extend the same circumferential distance from the slot liner 1102. In alternative examples, the fins 1100 may extend varying lengths, as with the fins 900 of FIG. 9B.

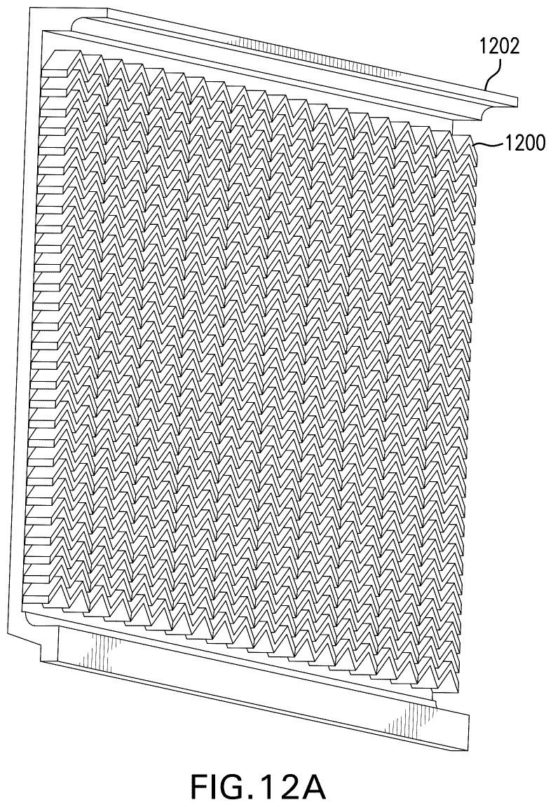

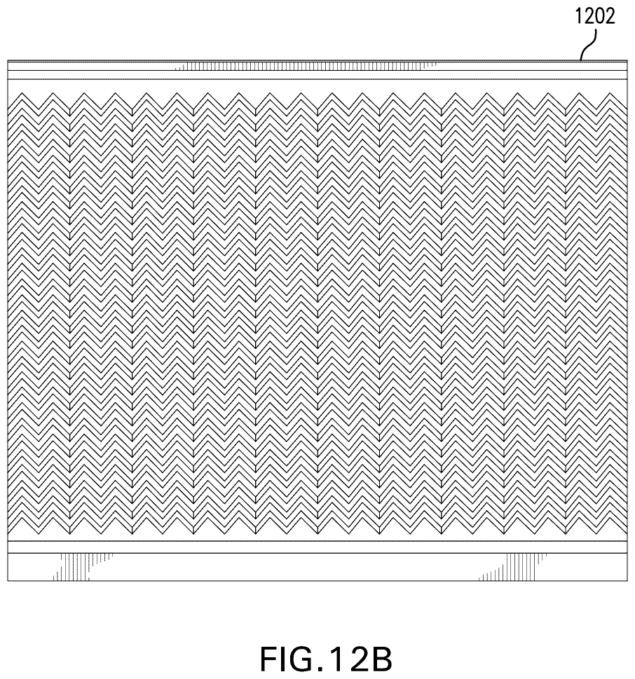

With continued reference to FIG. 1-8, FIG. 12A illustrates an isometric view and a circumferentially facing side view (12B) of a slot liner 1202 including fins 1200 having a circular profile. In the example of FIG. 10A, all the fins 1000 extend the same circumferential distance from the slot liner 1002. In alternative examples, the fins 1200 may extend varying lengths, as with the fins 900 of FIG. 9B.

With continued reference to all of FIGS. 1-12, the example fins 900, 1000, 1160, 1200 of FIGS. 9A, 10A, 11A and 12A may be used in combination within a single liner and/or different slots within a single stator construction may include the arrangements of FIGS. 9A, 10A, 11A and 12A in any combination. In some alternate examples, one or more of the fins 900, 1000, 1160, 1200 may not extend normal two the surface of the liner 902, 1002, 1102, 1202 and instead extend at an angle skew to the surface of the liner 902, 1002, 1102, 1202.

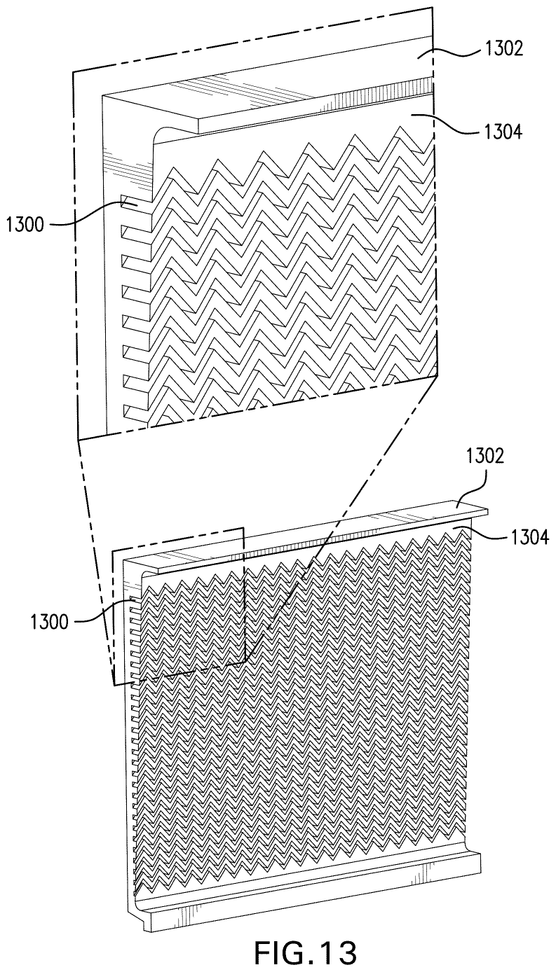

In yet another alternative embodiment, illustrated in isometric view at FIG. 13, the zigzag fin construction of FIG. 13? may be inverted resulting in a set of channels 1300 intruding circumferentially into a wall 1304 of the slot liner 1302. In such an example, the wall 1304 contacts the conductors 114, and maintains a circumferential positioning of the conductors within the slot.

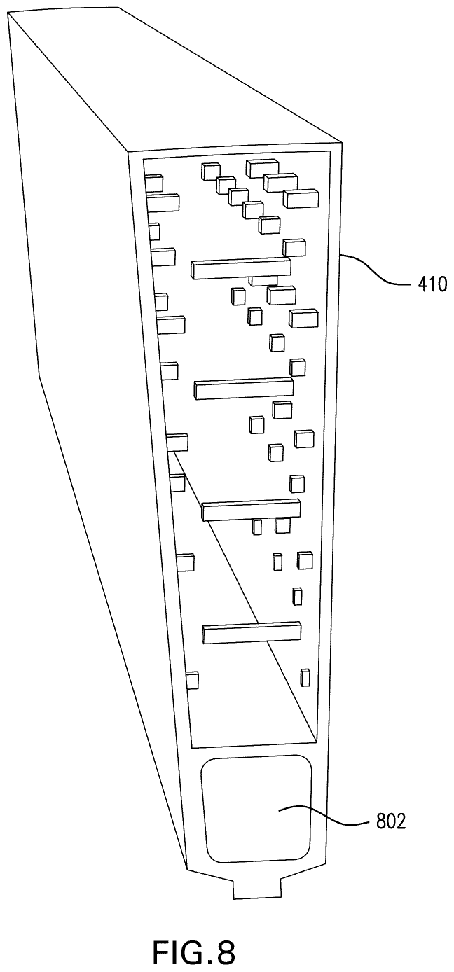

In some examples, such as the alternate example illustrated at FIG. 8, the slot liner 410 may include a segregated radially inward conductor section 802. The segregated conductor section 802 receives a radially inward most conductor winding and is not exposed to the cooling fluid flow. The alternate example of FIG. 8 may be used when sufficient cooling is provided via the remaining cooling flow.

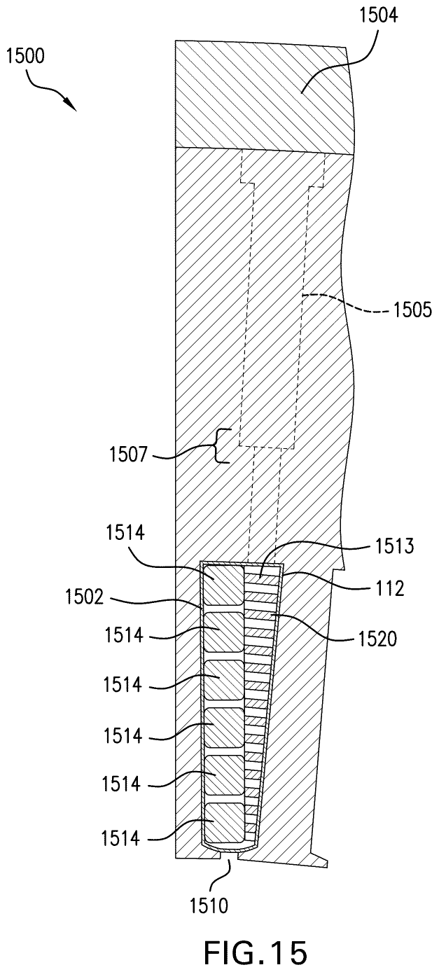

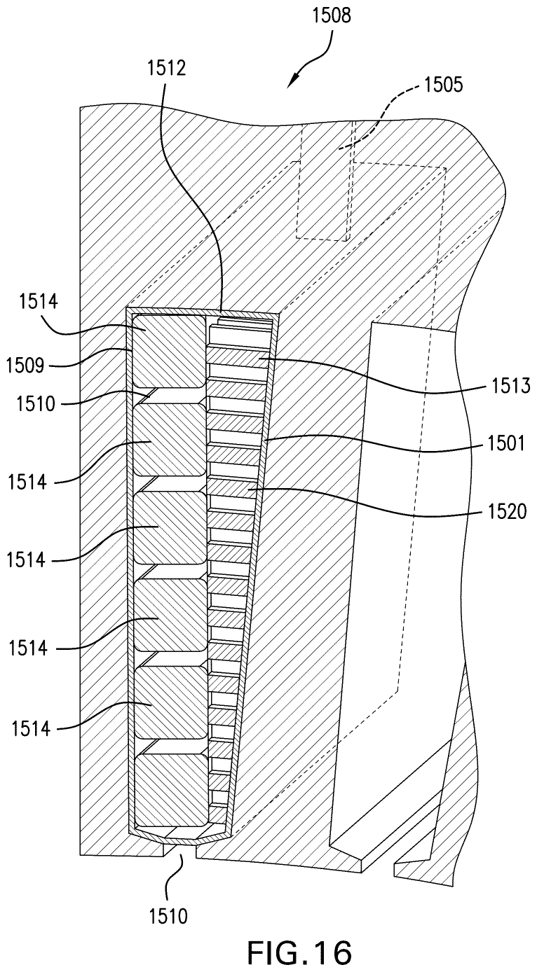

With continued reference to FIGS. 1-14, FIGS. 15 and 16 illustrate a single slot 1510 of an alternate configuration of the stator 1500. As with the example of FIG. 1, the slot 1510 contains a set of conductors 1514 which form the stator windings. A slot liner 112 is positioned in the slot 1510 and surrounds the conductors 1514. The conductors 1514 are maintained in position within the slot liner 1510 via a set of fins 1512 extending from one wall 1501 of the slot liner 1510. The set of fins 1512 press the conductors 1514 against a circumferentially opposite wall 1509.

In some examples, a subset of the fins in the set of fins 1512 extend along only a part of the circumference from the slot liner wall 1501 to the conductors 1514. This configuration provides a first subset of fins in the set of fins 1512 that maintain the position of the conductors 1514 and a second subset of fins in the set of fins 1512 that do not maintain the position of the conductors 1514.

The slot liner 1510 defines a void 1513, with the void 1513 being connected to channels 1504 via fluid connections 1505. The channels 1504 are substantially similar to the channels 104 of FIG. 1. The fluid connections 1505 include a metering portion 1507, with the metering portion 1507 being configured in the same manner as any of the metering portions 304 of FIGS. 3A, 3B and 3C.

The fins in the set of fins 1512 can have profiles matching any of the profiles illustrated in FIGS. 9A, 9B, 10A, 10B, 11A, 11B, 12A, or 12B, or be provided in any combination of the profiles illustrated in FIGS. 9A, 9B, 10A, 10B, 11A, 11B, 12A, or 12B.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% of a given value.

While the invention has been described with reference to an exemplary embodiment or embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A stator for an electric machine, the stator comprising:
an annular body and a plurality of radially inward slots;
wherein the stator defines a cooling fluid domain having a fluid inlet and a cooling fluid jacket at a radially outward portion of the stator, the cooling fluid domain further including a plurality of cooling fluid connections with each cooling fluid connection extending from the cooling fluid jacket to a corresponding radially inward slot such that each radially inward slot of the plurality of radially inward slots receives cooling fluid.

2. The stator of claim 1, further comprising:
each slot in the plurality of radially inward slots including a slot liner and a plurality of conductor windings; and
wherein a portion of the cooling fluid domain defined within each radially inward slot is divided.

3. The stator of claim 2, wherein each slot liner includes a set of fins extending toward a conductor winding of the conductor windings contained in the slot, the fins being configured to agitate cooling fluid flowing around the fins in the set of fins.

4. The stator of claim 3, wherein a subset of each set of fins contacts at least one corresponding conductor winding and maintains the at least one corresponding conductor winding in position within the radially inward slot.

5. The stator of claim 3, wherein at least a portion of each set of fins includes a foil cross section configured to impart particular flow characteristics on the cooling fluid flowing around the fin and thereby disrupt a boundary layer of the cooling fluid flow.

6. The stator of claim 2, wherein each fluid connection in the plurality of fluid connections includes a radially outward inlet portion, a metering portion and a divided outlet portion.

7. The stator of claim 6, wherein the metering portion includes a flow constriction immediately downstream of at least one of a sidewall angled relative to a cooling fluid flow direction, a sidewall curved relative to the cooling fluid flow direction, and a sidewall approximately normal to the cooling fluid flow direction.

8. The stator of claim 1, wherein each slot includes a plurality of conductor windings, wherein at least one of the conductor windings is isolated from the cooling flow by the slot liner.

9. The stator of claim 1, wherein the cooling fluid domain includes fluid outlets at each axial end of each slot of the radially inward slots.

10. The stator of claim 1, further comprising:
each slot in the plurality of radially inward slots including a slot liner and a plurality of conductor windings;
each slot in the plurality of radially inward slots including a set of windings positioned within the slot liner and being maintained in position at least in part via contact with a set of fins extending from a first radially aligned wall of the slot liner and contact with a second radially aligned wall of the slot liner.

11. An electric machine comprising:
a stator including an annular body;
a rotor radially inward of the stator;
the stator including a plurality of radially inward slots, each slot including a slot liner and a plurality of conductor windings; and
wherein the stator defines a cooling fluid domain having a fluid inlet and a cooling fluid jacket at a radially outward portion of the stator, the cooling fluid domain further includes a plurality of cooling fluid connections with each cooling fluid connection extending from the cooling fluid jacket to a corresponding radially inward slot, and wherein a portion of the cooling fluid domain defined within each radially inward slot is divided.

12. The electric machine of claim 11, wherein each slot liner includes a set of fins extending toward a conductor winding of the conductor windings contained in the slot, the fins being configured to agitate cooling fluid flowing around the fins in the set of fins.

13. The electric machine of claim 12, wherein a subset of each set of fins contacts at least one corresponding conductor winding and maintains the at least one corresponding conductor winding in position within the radially inward slot.

14. The electric machine of claim 12, wherein at least a portion of each set of fins includes a foil cross section configured to impart particular flow characteristics on the cooling fluid flowing around the fin and thereby disrupt a boundary layer of the cooling fluid flow.

15. The electric machine of claim 11, wherein each fluid connection in the plurality of fluid connections includes a radially outward inlet portion, a metering portion and a divided outlet portion.

16. The electric machine of claim 15, wherein the metering portion includes a flow constriction immediately downstream of at least one of a sidewall angled relative to a cooling fluid flow direction, a sidewall curved relative to the cooling fluid flow direction, and a sidewall approximately normal to the cooling fluid flow direction.

17. The electric machine of claim 11, wherein the slot liner includes a plurality of conductor windings, wherein at least one of the conductor windings is isolated from the cooling flow by the slot liner.

18. The electric machine of claim 11, wherein each slot liner in the plurality of slot liners is electrically non-conductive.

19. The electric machine of claim 1, wherein the cooling fluid domain includes fluid outlets at each axial end of each slot of the radially inward slots.

20. A method for cooling stator conductors in an electric machine, the method comprising:
providing a cooling fluid to a cooling fluid domain at a radially outward cooling fluid inlet, wherein the cooling fluid domain defines a cooling fluid jacket at a radially outward portion of a stator, the cooling fluid domain further defining a plurality of cooling fluid connections with each cooling fluid connection extending from the cooling fluid jacket to a corresponding radially inward slot, and wherein a portion of the cooling fluid domain defined within each radially inward slot is divided.
